(19) United States
(12) Patent Application Publication
(10) Pub. No.: US 2023/0043455 A1
(43) Pub. Date: Feb. 9, 2023

(54) CUSTOMIZED DISPLAY COLOR PROFILES FOR INDIVIDUAL COLOR PREFERENCE

(71) Applicant: Meta Platforms, Inc., Menlo Park, CA (US)

(72) Inventors: Huanzhao Zeng, San Diego, CA (US); Lin Chen, Redwood City, CA (US)

(21) Appl. No.: 17/861,664

(22) Filed: Jul. 11, 2022

Related U.S. Application Data
(60) Provisional application No. 63/230,227, filed on Aug. 6, 2021.

(51) Int. Cl. G09G 3/20; G06F 3/04847

(52) U.S. Cl. CPC G09G 3/2003; G06F 3/04847; G09G 2360/144; G09G 2354/00; G09G 2320/066; G09G 2360/16; G09G 2320/0666

(57) ABSTRACT

Customization of display color profiles is described. A first interface for customizing a global color preference is generated. Feedback from a user is received via the first interface. The feedback describes a customized global color preference. A second interface for customizing a memory color preference is generated. Feedback is received from the user via the second interface. The feedback describes the customized memory color preference. A color preference profile is generated using the customized global color preference and the customized memory color preference. The color preference profile describes the user's preference for how color is presented. The color preference profile is associated with a user profile of the user. Visual content is rendered on a display of the device in accordance with the color preference profile.

### CROSS-REFERENCE TO RELATED APPLICATIONS

This application claims the benefit of U.S. Provisional Application No. 63/230,227, filed Aug. 6, 2021, which is incorporated by reference in its entirety.

### FIELD OF THE INVENTION

This disclosure relates generally to display calibration, and more specifically to customizing display color profiles for individual color preferences.

### BACKGROUND

Color displays are traditionally characterized for colorimetric color reproduction. A simple display color characterization approach is to characterize a display as an sRGB display, i.e. to characterize the display to takes RGB input signals and display them on the screen colorimetrically. But conventional color standardization does not take into account individual human color preferences.

### SUMMARY

Customizing display color profiles and characterization for individual color preferences is described. A device generates a color preference profile that is customized to a user of the device. The customization addresses a global color preference and a memory color preference. The color preference profile is custom to the user, and describes the user's preference for how color is presented on a display of the device.

In some embodiments, a method is described. A first interface is generated for customizing a value for a global color preference. Feedback is received from a user, via the first interface. The feedback describes the customized global color preference. A second interface is generated for customizing a memory color preference. Feedback is received from the user, via the second interface. The feedback describing the customized memory color preference. A color preference profile is generated using the customized global color preference and the customized memory color preference. The color preference profile describes the user's preference for how color is presented. The color preference profile is associated with a user profile of the user, wherein visual content is rendered on a display in accordance with the color preference profile.

In some embodiments, a non-transitory computer-readable storage medium is described. The non-transitory computer-readable storage medium includes stored instructions, the instructions when executed by a processor of a device, cause the device to: generate a first interface for customizing a global color preference. The instructions further cause the device to receive feedback from a user, via the first interface, describing the customized global color preference, and generate a second interface for customizing a memory color preference. The instructions further cause the device to receive feedback from the user, via the second interface, describing the customized memory color preference, and generate a color preference profile using the customized global color preference and the customized the memory color preference. The color preference profile describes the user's preference for how color is presented. The instructions further cause the device to associate the color preference profile with a user profile of the user, wherein visual content is rendered on a display of the device in accordance with the color preference profile.

In some embodiments, a device is described. The device includes a display and a controller. The display is configured to display visual content in accordance with a color preference profile. The controller is configured to generate a first interface for customizing a global color preference, wherein the first interface is presented via the display. The controller is configured to receive feedback from a user, via the first interface, describing a customized global color preference. The controller is configured to generate a second interface for customizing a memory color preference, wherein the second interface is presented via the display. The controller is configured to receive feedback from the user, via the second interface, describing the customized memory color preference. The controller is configured to generate the color preference profile using the customized global color preference and the customized memory color preference, wherein the color preference profile describes the user's preference for how color is presented.

### BRIEF DESCRIPTION OF THE DRAWINGS

FIG. 1 is a block diagram of an example display system, in accordance with one or more embodiments.

FIG. 2 is a graphical representation of a color preference profile of a user, in accordance with one or more embodiments.

FIG. 3 shows an example of a graphical user interface being presented on a display of a device with controls through which a user may adjust global color preference, in accordance with one or more embodiments.

FIG. 4 shows an example of a graphical user interface being presented on a display of a device with controls through which a user may adjust memory color preference, in accordance with one or more embodiments.

FIG. 5 is a flowchart illustrating a process for generating a color preference profile customized to a user, in accordance with one or more embodiments

FIG. 6 is a block diagram of a system environment for a communication system, in accordance with an embodiment

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Customizing display color profiles and characterization for individual color preferences is described. A device (e.g., computer display, tablet, wearable device, communication system, etc.) presents interfaces to a user through which feedback may be provided to customize global color preferences for the user. Global color preference describes display parameters (e.g., contrast) that may be applied to all colors. The device also presents interfaces to the user through which feedback may be provided to customize memory color preferences for the user for one or more memory colors. Memory color preference describes a set of canonical colors of different types of objects (e.g., sky, grass, trees, faces, etc.) that human observers acquire through their experiences with instances of that type. Memory colors may be commonly perceived colors of objects, which may depend on a living environment or culture (e.g., the frequency of colors used may correspond to natural colors prevalent in an environment or may vary based on cultural meaning). The device uses the feedback to generate a color preference profile that is customized to a user of the device. The customization addresses display parameters (e.g., contrast) for global color preference and display parameters (e.g., hue) for memory color preference of one or more specific canonical colors. The color preference profile is custom to the user, and describes the user's preference for how color is presented on a display of the device.

Note that the device may have multiple users, wherein each user has an associated user profile. The device may associate the color preference profile of user with a user profile of the user. Accordingly, when a particular user logs into a device, the device may retrieve (e.g., from local storage social graph, etc.) a color preference profile custom for that user from that user's user profile (may be locally stored or stored remotely), and then render visual content on a display of the device in accordance with the retrieved color preference profile.

Traditional display color characterization is based on colorimetric color calibration. Depending on the display technology, the color characterization methods are slightly different. CRT display color characterization is based on the measurement of black, white, and primaries, and then deriving a gamma curve and a 3×3 matrix for colorimetric transformation. In LCD and LED displays, due to more nonlinear tone characteristics and inter-channel dependency, more complex models may be applied for colorimetric characterization. If an ambient sensor is available, ambient light adaptation may be applied to adjust the display white point and contrast to improve color appearance. At the end, a display panel calibration block is to calibrate the panel variation so that each panel performs as closely as possible to the golden panel. In the TV display and mobile display market, saturation boosting has been applied to increase color saturation and to expand gamut beyond sRGB. However, the deviation from colorimetric characterization is not based on user color preference but performed in the manufacture. In contrast, described herein is a device that performs a color characterization step as well as a step of individual color preference enhancement.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to create content in an artificial reality and/or are otherwise used in an artificial reality. The artificial reality system that provides the artificial reality content may be implemented on various platforms, including a wearable device (e.g., headset) connected to a host computer system, a standalone wearable device (e.g., headset), a mobile device or computing system, or any other hardware platform capable of providing artificial reality content to one or more viewers.

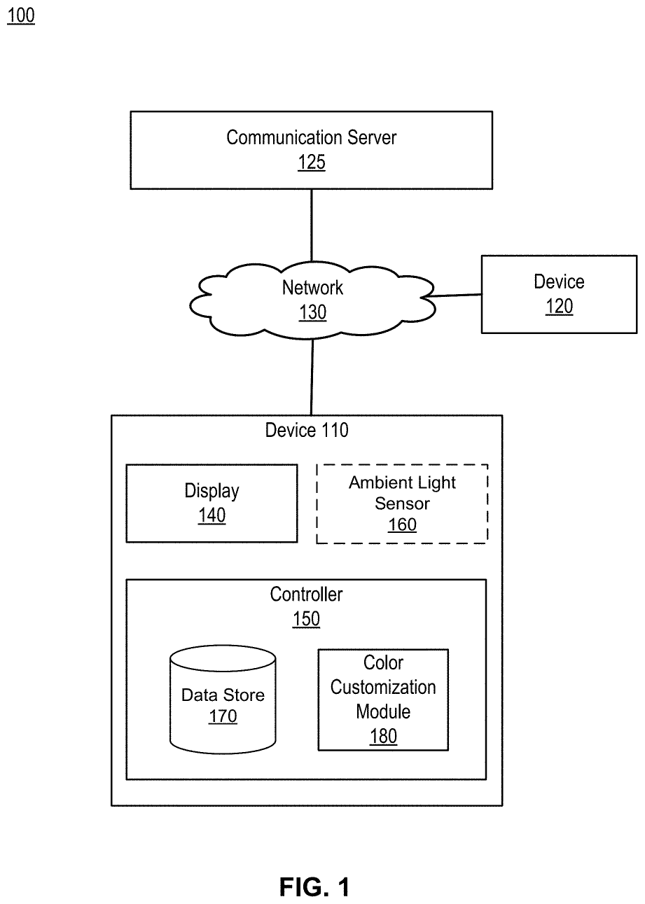

FIG. 1 is a block diagram of an example display system 100, in accordance with one or more embodiments. The display system 100 customizes display color profiles to individual color preferences. The custom display color profiles may then be used by one or more devices of the display system 100 to present content to the user. In the embodiment of FIG. 1, the display system 100 includes a device 110, that may optionally be coupled to a device 120 and/or a communication server 125 via a network 130. Some embodiments of the display system 100 have different components than those described here. Similarly, in some cases, functions can be distributed among the components in a different manner than is described here.

The network 130 may comprise any combination of local area and/or wide area networks, using wired and/or wireless communication systems. In one embodiment, the network 130 uses standard communications technologies and/or protocols. For example, the network 130 uses an ultra-wideband (UWB) protocol to establish a secure communication link between one or more client devices 615 and the communication system 620. In other examples, the network 130 establishes communication links using technologies such as Ethernet, 802.11 (WiFi), worldwide interoperability for microwave access (WiMAX), 3G, 4G, 5G, code division multiple access (CDMA), digital subscriber line (DSL), BLUETOOTH®, Near Field Communication (NFC), Universal Serial Bus (USB), or any combination of protocols. In some embodiments, all or some of the communication links of the network 130 may be encrypted using any suitable technique or techniques.

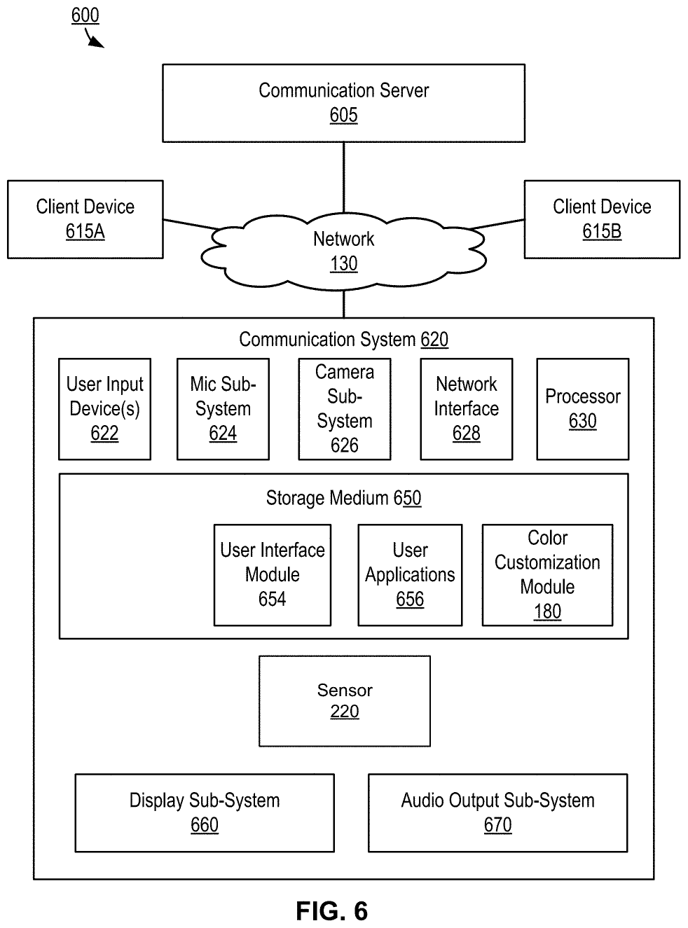

The device 110 customizes display color profiles to individual color preferences. The device 110 may include a display and or control an external display (e.g., LCD monitor). The device 110 may be, e.g., a computer, a tablet, a smartphone, a communication system (e.g., as described below with regard to FIG. 6), a television, headset, smartwatch, some other device that controls and/or includes a display. The device 110 includes a display 140 and a controller 150, and may optionally include an ambient light sensor (ALS) 160.

The display 140 presents images in accordance with instructions from the controller 150. The display 140 may be, e.g., a liquid crystal display (e.g., light-emitting diode backlit LCD, thin-film transistor LCD, Quantum dot display), a waveguide display, a light-emitting diode display (e.g., organic light emitting diode display, an active matrix organic light-emitting diode display, etc.), some other device that presents images, or some combination thereof. The display 140 renders images in accordance with a color preference profile of a user of the device 110 (and more specifically of the display 140).

The ALS 160 is configured to determine ambient light properties of a local area of the display 140. Ambient light properties are values of brightness in one or more color channels (e.g., red, green, blue) for the local area. For example, the ALS may include pixels for detecting red light, green light, blue light, infrared light, ultraviolet light, wide band (e.g., no filter), or some combination thereof. The ambient light properties may be used for determining white balance under different lighting conditions (e.g., natural light v. fluorescent lighting).

The controller 150 controls components of the device 110. In the embodiment of FIG. 1, the controller 150 includes a data store 170, and a color customization module 180. The controller 150 may be located on an external device, in some embodiments. For example, the display 140 may be a display that is separate from, but communicatively coupled to the controller 150. Some embodiments of the controller 150 have different components than those described here. Similarly, functions can be distributed among the components in different manners than described here. For example, some functions of the controller may be performed external to the device 110. The user may opt in to allow the controller 150 to transmit color preference profiles determined on the device 110 to systems external to the device 110 (e.g., the device 120 and/or the communication server 125), and the user may select privacy settings controlling access to any such data.

The data store 170 stores data for use by the device 110. Data in the data store 170 may include one or user profiles, color preference profiles for one or more users, global color preferences for one or more users, memory color preferences for one or more users, images that facilitate customization of the global color preference, images that facilitate customization of memory color preferences for one or more different canonical colors; or any combination thereof. The color preference profile is custom to a user, and describes the user's preference for how color is presented on a display (e.g., the display 140) of a device.

Global color preference describes display parameters that may be applied to all colors. Global color preference display parameters may include, e.g., contrast, color saturation, brightness, some other display parameter that may be applied to all colors, or some combination thereof. Images that facilitate customization of the global color preference can depict content using various colors, brightness, and contrast. A user may choose familiar images that can show modifications in brightness, contrast, and color saturation when selecting these global parameters. In a first example, an image having shadow, highlight, and mid tones may be used to select global parameters for brightness and contrast adjustment. In a second example, images with a variety of colors from objects or the environment such as grass, trees, sky, and construction materials (e.g., metallics, clays, wood, brick, etc.) can be used to select global parameters for saturation and/or hue adjustment. As values of display parameters for global color preference may be applied to all colors, they may be referred to as being global. For example, a contrast value, may be referred to as a global contrast value; a value for saturation may be referred to as a global saturation value; and a value for brightness may be referred to as a global brightness value.

Memory color preference describes a set of canonical colors of different types of objects (e.g., sky, metal, skin, grass, tomato, etc.) that human observers acquire through their experiences with instances of that type. For example, most human observers know that a tomato typically has a reddish color; this knowledge about the canonical color which is represented in memory constitutes a memory color. The canonical colors may include, e.g., skin tone, green foliage, blue sky, red objects, some other canonical color, or some combination thereof. Note that certain different canonical colors may be more important in some cultures. For example, red is very important in Asia, so the memory color preference may include red objects for the Chinese market, and might not include it in other markets where red is of less import (e.g., Norway). Each memory color preference canonical color may be described by a value for hue, a value for saturation, and a value for brightness. Images that facilitate customization of memory color preference are associated with specific canonical colors. For example, if the canonical color is blue sky, images that would facilitate customization of the memory color preference for blue sky may include, e.g., images that include large portions of a blue sky (e.g., at least 50% of image is of the sky). In a similar manner, if the canonical color is green foliage, images that would facilitate customization of the memory color preference for green foliage may include, e.g., images that include large portions vegetation (e.g., forests, fields, shrubs, etc.).

Note that the actual implementation of the color preference profile depends on a display color architecture. For example, if the display hardware or software supports three dimensional (3D) color look up table (LUT), the color preference profile may be generated as a 3D LUT and be merged with an existing 3D LUT for display color transformation. If the display color transformation is implemented in one dimensional (1D) LUT, two dimensional (2D) LUT, or the combination of 1D and 2D LUTs, the color preference profile can be converted into 1D and/or 2D LUTs to approximate the color preference transformation. A color preference engine may be developed using a graphics processing unit (GPU) or hardware implementation for dedicated color preference transformation.

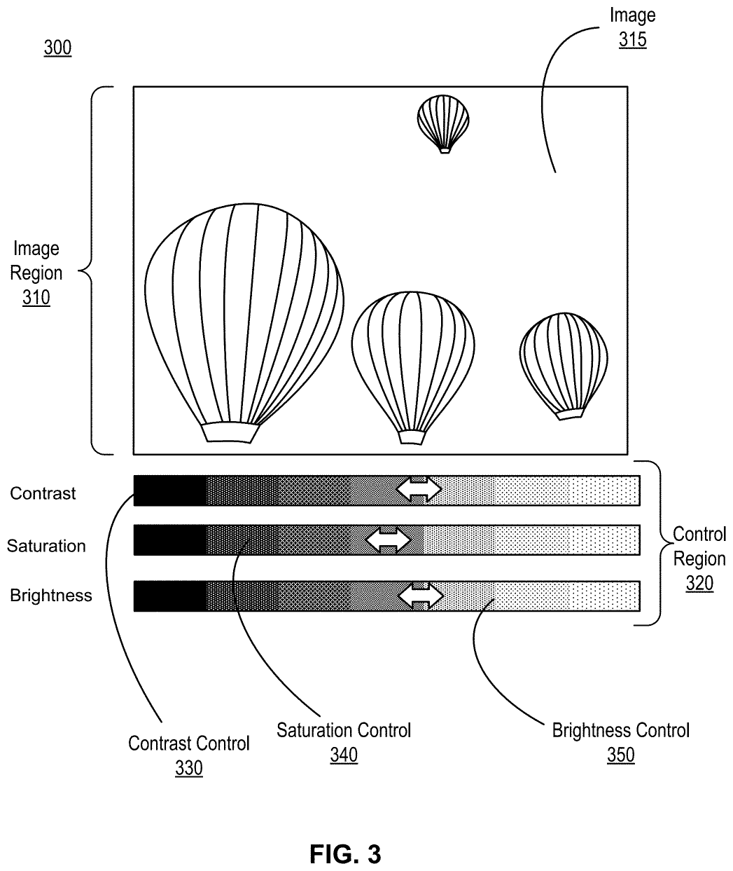

The color customization module 180 is configured to generate an interface through which the user customizes a global color preference. The interface may be a graphical user interface (GUI) that is presented via the display 140. In other embodiments, the interface may be a combination of the display 140 and other controls (e.g., physical buttons). The color customization module 180 may retrieve an image of a scene to facilitate customization of the global color preference. The system may keep a set of default images for preference adjustment and also has an option for users to select their own images. An image that covers shadow, mid tone, and highlight image contents may be used for brightness and contrast adjustment. An image that covers rich colors with various saturations and hues may be used for saturation and hue adjustment. A carefully selected image that shows effect of every global adjustment features may be used to adjust all global color preference properties, or a separate image may be used to adjust each of brightness, contrast, saturation, and hue, or multiple images for adjusting a property. The color customization module 180 may instruct the display 130 to render the image using initial values and/or values previously set for the display parameters (e.g., contrast, color saturation, brightness). The interface presents, via the display 140, the generated image. The interface uses information from and/or may include one or more controls that the user may use to adjust the values of the display parameters associated with global color preference, specifically contrast, color saturation, brightness, or some combination thereof. The one or more controls may be e.g., touch screen with soft buttons, slider, etc., a physical interface (e.g., buttons, dials, etc.) on the device, or some combination thereof. As the user adjusts a value of a display parameter (e.g., contrast), the interface dynamically adjusts the image being presented to render according to the adjusted display parameter. Once the user's feedback is complete (e.g., user hitting a next button), the display parameters are updated in accordance with the adjusted display parameters. In this manner, the user is able to customize the global color preference to align with a preferred presentation of the user. The received feedback describes a customized global color preference that is specific to the user. An example interface for customization a value for a global color preference is described below with regard to FIG. 3.

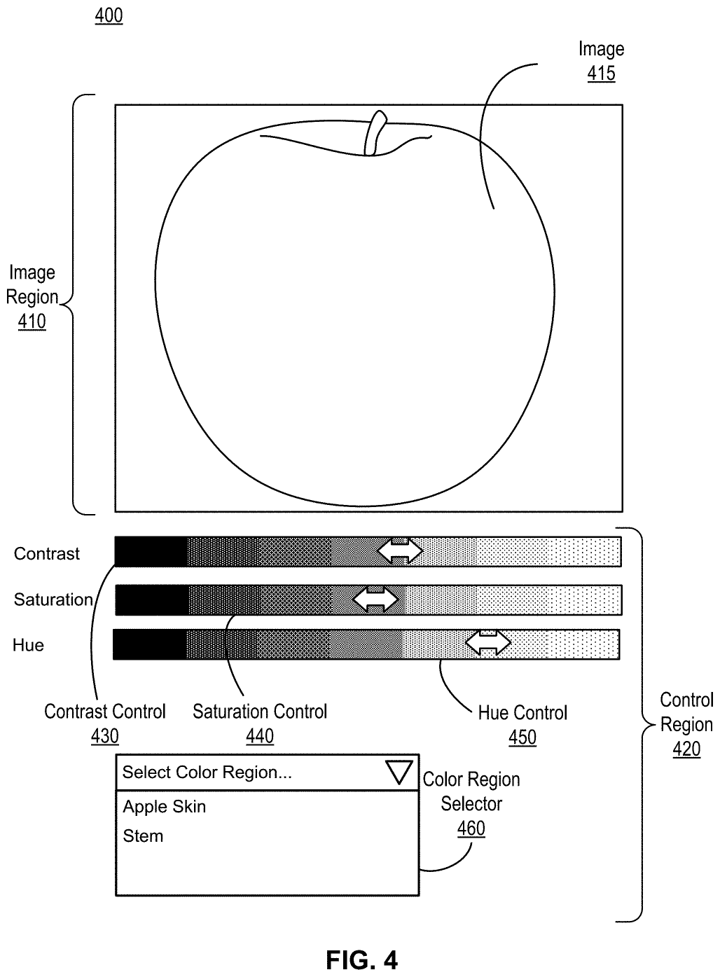

The color customization module 180 is configured to generate an interface through which the user customizes a memory color preference. The interface may be a GUI that is presented via the display 140. In other embodiments, the interface may be a combination of the display 140 and other controls (e.g., physical buttons). In some embodiments, the interface is similar to interface as the one used to customize global color preference. The color customization module 180 selects a first canonical color (e.g., green foliage color preference) of the set of canonical colors of memory color preferences. The color customization module 180 may retrieve an image of a scene representative of the selected canonical color that is rendered using initial values and/or values previously set for the display parameters (e.g., hue, saturation). The interface presents, via the display 140, the generated image. The interface uses information from and/or may include one or more controls that the user may use to adjust the values of the display parameters. The one or more controls may be e.g., touch screen with soft buttons, slider, etc., a physical interface (e.g., buttons, dials, etc.) on the device, or some combination thereof. As the user adjusts a value of a display parameter (e.g., hue), the interface dynamically adjusts the image being presented to render according to the adjusted display parameter. Once the user's feedback is complete (e.g., user hitting a next button), the display parameters are updated in accordance with the adjusted display parameters. In this manner, the user is able to customize the memory color preference to align with their preferred presentation. The received feedback describes a customized memory color preference that is specific to the user. An example interface for customization of a memory color preference is described below with regard to FIG. 4.

The color customization module 180 repeats the above process of customizing a memory color preference for a different canonical color. For example, if the interface was presenting an image for green foliage color preference, the color customization module 180 may perform a similar customization for the blue sky color preference, where an image representative of the blue sky is retrieved, and rendered in accordance with the current set of display parameters. And like above, as the user customizes one or more values of display parameters (e.g., hue, saturation, and/or brightness) for the presented image, the interface dynamically adjusts the image being presented to render according to the adjusted display parameter. In some embodiments, the color customization module 180 repeats this process until each of the memory color preferences are customized.

Note that the color customization module 180 may generate and present additional images as part of a customization for a given canonical color of memory color preference (e.g., red object, green foliage, blue sky, metal, etc.). For example, if the canonical color is skin tone, the device may generate a plurality of images that are each representative of people with different skin tones (e.g., an image of a white woman, an image of a black man, an image of a Chinese man, an image of a Latin woman, etc.). The color customization module 180 may collect user feedback for each image presented for the customization of the canonical color of memory color preference.

In the above description, the global color preference is customized first, and then the memory color preference is customized. In other embodiments, some or all of the memory color preference for the set of canonical colors may be customized prior to the global memory color preference.

The color customization module 180 is configured to generate a color preference profile using the customized global color preference and the customized memory color preference. The color preference profile describes the user's preference for how color is presented.

The color customization module 180 is configured to associate the color preference profile with a user profile of the user. In this manner, visual content is rendered by the display 140 in accordance with the color preference profile on the device 110. In some embodiments, the color customization module 180 may upload the color preference profile to the communication server 125 via the network 130 (e.g., so that the color preference profile may be later used by a different device associated with the user). In some embodiments, the controller 150 may retrieve a color preference profile from the communication server 125 and/or the device 120 (subject to user permissions) responsive to receiving login credentials (e.g., user identifying information) from the user.

The communication server 125 maintains color preference profiles for one or more users. The communication server 125 may be, e.g., a social networking server, a cloud server, an entertainment provider server, some other server that maintains or is communicatively coupled to some other server that maintains color preference profiles, or some combination thereof. The communication server 125 may maintain them, e.g., as part of a social graph. The communication server 125 may receive a request from a device (e.g., the device 120 and/or the device 110) for color preference profile associated with a requesting user of the device. The communication server 125 authenticates the request. Responsive to the request being authenticated the communication server 125 may retrieve and distribute the requested color preference profile of the requesting user to the requesting device subject to permissions of the user.

In this manner, once a color preference profile is generated for a user, it can be retrieved and used by other devices used by the user without having to re-create the color preference profile on those other devices. And as some devices (e.g., TV in a hotel, library facilities, etc.) have multiple users, the described methodology facilitates each user having a different customized color preference profile. For example, after the user logs into the device, the display may retrieve the color preference profile from the user profile and then render visual content on the display in accordance with the color preference profile.

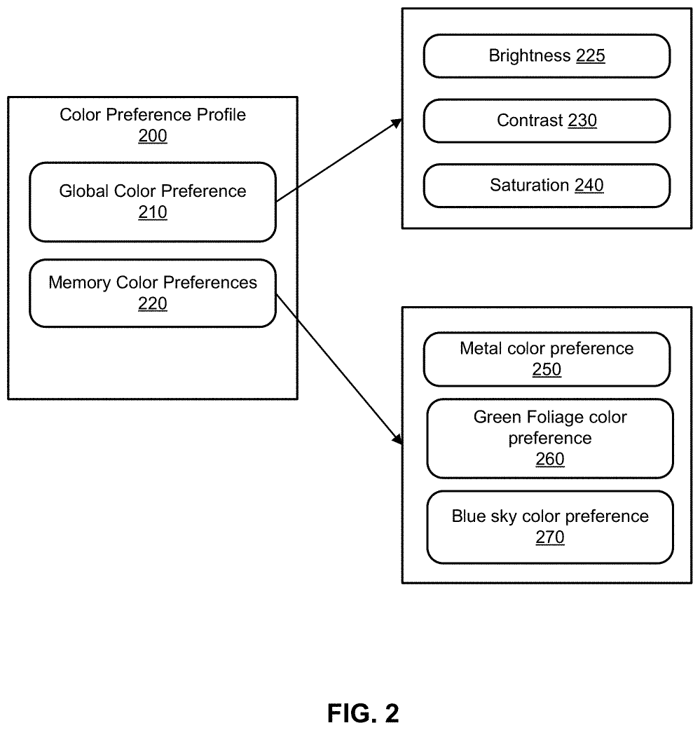

FIG. 2 is a graphical representation of a color preference profile 200 of a user, in accordance with one or more embodiments. The color preference profile 200 includes a global color preference 210, and a plurality of memory color preferences 220. The global color preference 210 describes display parameters that may be applied to all colors. As illustrated the global color preference includes values for brightness 225, contrast 230, and saturation 240 (e.g., color saturation). But in other embodiments, it could also include values for some display parameter that may be applied to all colors. As illustrated the memory color preferences 220 describes three canonical colors, specifically, a metal color preference 250, a green foliage color preference 260, and blue sky color preference 270. Each of these canonical colors is described via a corresponding set of values of display parameters (e.g., contrast, saturation, and hue).

FIG. 3 shows an example of a GUI 300 being presented on a display of a device with controls through which a user may adjust global color preference, in accordance with one or more embodiments. The device may be, e.g., the device 110. The GUI 300 includes an image region 310 and a control region 320. Additional global color preferences may be included in the GUI 300. For example, although not depicted, a hue adjustment slider may be included for global hue adjustment.

The image region 310 presents one or more images to facilitate customization of the global color preference. As illustrated the image region 310 is presenting an image 315. Note that the image is selected by the device to facilitate customization of the global color preference for the user. In some embodiments, the images presented for adjusting global color preferences may include different images to adjust different permutations of global color preferences. For example, a first image may be selected due to its depiction of multiple, differently colored objects to adjust a global color preference for contrast and saturation and a second image may be selected due to a depiction of illuminated objects against a dark background to adjust a global color preference for brightness. Alternative to or in addition to different images used to adjust different global color preferences, a single image may be used to adjust all global color preferences. Because the images are selected for global color preference adjustment, images used in this step may show effects of global adjustments.

The control region 320 includes one or more controls for adjusting specific display parameters that affect global color preference and how the image 315 is presented by the display. As shown, the control region 320 includes a contrast control 330, a saturation control 340, and a brightness control 350. In other embodiments, there may be different controls (e.g., just a contrast control 330 and a saturation control 340, but no brightness control 350). A hue control may be included for global hue adjustment, although not depicted in FIG. 3. In this example each of the controls (i.e., contrast control 330, saturation control 340, and brightness control 350) are sliders. In other embodiments, some or all of the controls may take some other form (e.g., dial).

The GUI 300 receives feedback from a user of the GUI 300 via the one or more controls. The device dynamically updates how the image 315 is presented based on the received feedback. For example, increase an amount of brightness via the brightness control 350, results in the device increasing the brightness in the image 315. In this manner, the user is able to customize display parameters that set the global color preference for the user.

In some embodiments, once the user has indicated acceptance of values of the display parameters being controlled by the GUI 300, the GUI 300 may retrieve and present a different image to facilitate customization of the global color preference. In some embodiments, the GUI 300 may automatically set initial values for the display parameters in accordance with the feedback received for the prior image. And the GUI 300 may allow the user to further adjust the display parameters via the one or more controls.

In other embodiments, the GUI 300 may sequentially receive feedback (i.e., via the one or more controls) from the user for different images, the feedback including values for the display parameters. In some embodiments, after storing a set of display values for a particular image, the initial values of the display parameters are reset to a default position for each new image. When displaying and adjusting the image, the result can be shown on a screen for preview. After selecting a button (e.g., an Accept or OK button) to accept the adjustment, the adjustment parameters may be recorded and applied. If another image is opened to continue adjustment, a subsequently selected adjustment may be applied on top of the previously selected adjustment. Continuing the cycle with additional images, adjustments may be cumulated. The GUI 300 may include a button to reset one or more of the adjustments (e.g., if a user is not satisfied with the adjustment(s)).

The device may use, e.g., a weighted combination of the display values received for each image to generate the display values for the global color preference. The weights for the display values may be based one, e.g., features of the image presented to the user while they were obtained. For example, a user may select different adjustment values in response to being presented different images, and the final color saturation value may be a weighted average based on weights applied to the types of images used for adjustment. In some embodiments, the color customization module 180 may categorize images into types (e.g., based on objects depicted, variation in hues, an amount of light captured within the image, etc.) and determine weights to be applied to images based on a one or more properties of the images (e.g., an image depicted more, differently colored objects is weighed higher than an image depicting a single object).

FIG. 4 shows an example of a GUI 400 being presented on a display of a device with controls through which a user may adjust memory color preference, in accordance with one or more embodiments. The device may be, e.g., the device 110. The GUI 400 includes an image region 410 and a control region 420.

The image region 410 presents one or more images to facilitate customization of the memory color preference. As illustrated the image region 410 is presenting an image 415. Note that the image is selected by the device to facilitate customization of the global color preference for the user. In this example, the memory color preference is a red object. As such the device selects an image of a red apple to be presented as the image 415 in the image region 410.

The control region 420 includes one or more controls for adjusting specific display parameters that affect global color preference and how the image 415 is presented by the display. As shown, the control region 420 includes a contrast control 430, a saturation control 440, and a hue control 450. In other embodiments, there may be different controls (e.g., just the saturation control 440 and the hue control 450, but no contrast control 430, or a brightness control may be added for local brightness adjustment). In this example each of the controls (i.e., contrast control 430, saturation control 440, and hue control 450) are sliders. In other embodiments, some or all of the controls may take some other form (e.g., dial). The control region further includes a color region selector 460 to specify a portion of the image 415 to apply the effects of adjusting the controls. The color region selector 460 is a dropdown menu including predetermined portions of the image as options. In some embodiments, the GUI 400 may include a tool for customizing the portion of the image 415 to adjust (e.g., a freeform marker to draw a shape around an area of the image the user requests to adjust). The predetermined portions of the image 415 may be determined by the color customization module 180 (e.g., applying an object classification algorithm, such as a machine learning model, or an image processing algorithm that partitions portions of the image by shades of color).

The GUI 400 receives feedback from a user of the device via the one or more controls. The device dynamically updates how the image 415 is presented based on the received feedback. For example, increase an amount of hue via the hue control 450, results in the device increasing the amount of red hue in the image 415. In this manner, the user is able to customize display parameters that set the memory color preference for the user.

Note that both the contrast control 430 and the saturation control 440 are also associated with setting the global color preference for the user. The global color preference can be applied globally to all colors, while each memory color control may only be applied to a corresponding local color region. Memory color processing may be applied on top of the global color processing. For example, global saturation can be increased by 10% (1.1 is multiplied to the color saturation of every color globally, including memory colors). Further in this example, a color saturation of a local color region, such as red, may be by 15% (1.15 is multiplied to the color saturation of red). Thus, the total color saturation adjustment in the color red is 1.1×1.15=1.265. To have a smooth transition from red to non-red colors, the 15% color saturation in red can be gradually reduced to 0% around the boundary between red and nearby colors. In the memory color adjustment depicted in FIG. 4, the selected memory color region can determine the color region for local contrast, saturation and hue adjustment. For example, if the “Apple Skin” region is selected, the internal algorithm applies adjustments on the defined apple skin color region only. If the “Stem” region is selected, the internal algorithm can apply adjustments on the corresponding stem color region only.

In some embodiments, once the user has indicated acceptance of values of the display parameters being controlled by the GUI 400, the device may retrieve and present via the GUI 400 a different image for the same canonical color to facilitate customization of the memory color preference. And the customization process may repeat some number of times (e.g., predetermined number) or until a user provides feedback via the GUI 400 that they are satisfied with the result. Once the display values for a particular canonical color are finalized, the device may repeat the above process for a different canonical color of a set of canonical colors available to the device. Once display parameters are finalized for each of the set of canonical colors, the memory color preference for each of the set of canonical colors is set for the user.

In some embodiments, for a given canonical color, the GUI 300 may automatically set initial values for the display parameters in accordance with the feedback received for the prior image. And the GUI 300 may allow the user to further adjust the display parameters via the one or more controls. In other embodiments, the GUI 300 may sequentially receive feedback (i.e., via the one or more controls) from the user for different images, the feedback including values for the display parameters for the canonical color. In some embodiments, after storing a set of display values for a particular image, the initial values of the display parameters are reset to a default position for each new image of the same canonical color. The GUI 300 may display different images to repeat adjustment, and the adjustments can be accumulated. In an example of hue adjustment, the default adjustment can be zero degrees. After displaying a red apple to adjust a red hue, the user may set to +4 degrees of adjustment. The adjusted hue angle may then be the input hue angle plus 4 in response to the use of hue addition for hue adjustment. Subsequently, in response to a user selecting another image to adjust red hue by −1, the color customization module 180 may determine that the total hue adjustment is the sum of the two adjustments, which is 4+(−1)=3 degrees.

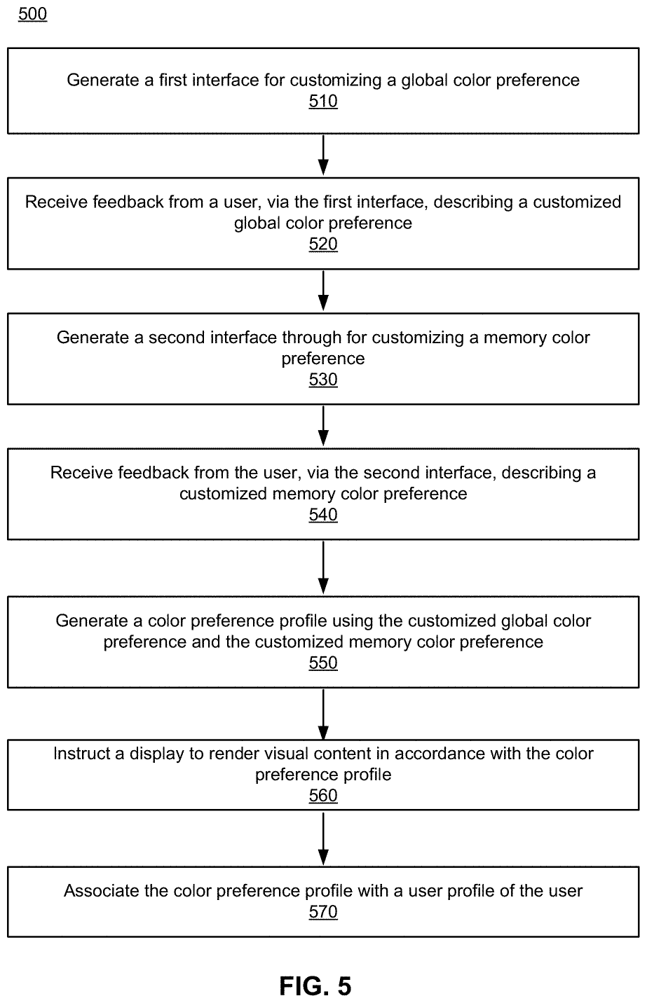

FIG. 5 illustrates a process 500 for generating a color preference profile customized to a user, in accordance with one or more embodiments. The process shown in FIG. 5 may be performed by components of a device (e.g., device 110) that includes and/or controls a display. Other entities may perform some or all of the steps in FIG. 5 in other embodiments. Embodiments may include different and/or additional steps, or perform the steps in different orders.

The device generates 510 a first interface for customizing a global color preference. The generated interface includes a plurality of controls (e.g., dials, sliders, etc.) corresponding to a plurality of display parameters (e.g., contrast, saturation). The device selects, via a controller, an image that facilitates customization of the global color preference. The device instructs a display of the device to present the plurality of controls and the selected image. And example first interface is described above with reference to FIG. 3.

The device receives 520 user feedback via the first interface. The user feedback describes the customized global color preference. For example, the user feedback may be values for one or more of the display parameters being adjusted by the controls. The device updates the first interface in response to receiving the feedback from the user. For example, the device modifies, in real time as the user adjusts a control, of the controls, the displayed image in accordance with the adjusted display parameter.

The device generates 530 a second interface through which the user customizes a memory color preference. The generated interface includes a plurality of controls (e.g., dials, sliders, etc.) corresponding to a plurality of display parameters (e.g., hue, saturation). The device selects a canonical color. The canonical color may be selected from a set of canonical colors (e.g., red, blue sky, green foliage, skin tone, metal, etc.) The device selects an image including the canonical color. The device instructs the display to present the plurality of controls and the selected image.

The device receives 540 user feedback via the second interfaces. The user feedback describes the customized memory color preference. For example, the user feedback may be values for one or more of the display parameters being adjusted by the controls. The device updates the second interface in response to receiving the feedback from the user. For example, the device modifies, in real time as the user adjusts a control, of the controls, the displayed image in accordance with the adjusted display parameter. Note, in some embodiments, once values for display parameters associated with the selected canonical color are determined, the device may repeat steps 530 and 540 for different canonical colors in the set of canonical colors. In some embodiments, the device may repeat steps 530 and 540 for each of the canonical colors in the set of canonical colors.

The device generates 550 a color preference profile using the customized global color preference and the customized memory color preference. The color preference profile can record data differently, depending on the hardware and software capability. In some embodiments, the color preference profile can be the record of all color preference parameters. Additionally or alternatively, a device has hardware for processing 3D lookup table (LUT), and a 3D LUT may be generated by applying all global and local color preference adjustment parameters. If a device only supports 1D and 2D LUTs, the color preference profile may be used to generate these LUTs. In some embodiments, the color preference profile may be used to generate an industry standard International Color Consortium (ICC) profile.

The device instructs 560 the display to render visual content in accordance with the color preference profile. The device modifies default display parameters in accordance with values of the display parameters in the color preference profile. The device uses the modified display parameters in rendering content to the user (e.g., while the user is logged into the device). Once a user logs out of the device the device may revert to rendering content using the default display parameters.

The device associates 570 the color preference profile with a user profile of the user. In this manner, after a user logs into the device, the device may extract the color preference profile from the user profile. Note in some embodiments, the device may upload the color preference profile to a communication server (e.g., the communication server 125). The communication server may, e.g., update a social graph with the color preference profile. In this manner, responsive to a request from a second device of the user, the communication server can provide the user profile to the second device (subject to the user's permissions), such that visual content rendered on the second device is rendered in accordance with the color preference profile of the user.

FIG. 6 is a block diagram of a system environment 600 for a communication system 620. The system environment 600 includes a communication server 605, one or more client devices 615 (e.g., a client device 615A and a client device 615B), and a communication system 620 that are coupled together via the network 130. In alternative configurations, different and/or additional components may be included in the system environment 600. For example, the system environment 600 may include additional client devices 615, additional communication servers 605, or additional communication systems 620.

The communication system 620 may be an embodiment of the client device 110. In various embodiments, the communication system 620 is an embodiment of a public device and can establish a secure communication between the public device and one or more personal devices. In an example, the communication system 620 comprises an integrated computing device that operates as a standalone network-enabled device. In another example, the communication system 620 comprises a computing device for coupling to an external media device such as a television or other external display and/or audio output system. In this example, the communication system 620 may couple to the external media device via a wireless interface or wired interface (e.g., an HDMI cable) and may use various functions of the external media device such as its display, speakers, and input devices. Here, the communication system 620 may be configured to be compatible with a generic external media device that does not have specialized software, firmware, or hardware specifically for interacting with the communication system 620.

The client devices 615 are one or more computing devices capable of receiving user input as well as transmitting and/or receiving data via the network 130. In one embodiment, a client device 615 (also referred to as a “personal device”) is a device having computer functionality, such as a personal digital assistant (PDA), a mobile telephone, a smartphone, a tablet, an Internet of Things (IoT) device, a video conferencing device, a watch, a headset, another wearable device, another instance of the communication system 620, or another suitable device. In some embodiments, the client device 615 is configured to collect and/or store user data which can include personal identifying information (PII). Other user data being collected by and/or stored on the client device 615 may include interaction data, location data, communication data, preferences or settings (e.g., color preference profile, memory color preference, global color preference), permissions, user account information, other suitable data of the user, or any combination thereof.

A client device 615 is configured to communicate via the network 130. In one embodiment, a client device 615 executes an application allowing a user of the client device 615 to interact with the communication system 620 by enabling voice calls, video calls, data sharing, or other interactions. For example, a client device 615 executes a browser application to enable interactions between the client device 615 and the communication system 620 via the network 130. In another embodiment, a client device 615 interacts with the communication system 620 through an application running on a native operating system of the client device 615, such as IOS® or ANDROID™.

The communication server 605 facilitates communications of the client devices 615 and the communication system 620 over the network 130. For example, the communication server 605 may facilitate connections between the communication system 620 and a client device 615 when a voice or video call is requested. Additionally, the communication server 605 may control access of the communication system 620 to various external applications, services, or other servers available over the network 130. For example, the communication server 605 may provide the communication system 620 access to a third-party server (e.g., a social networking server, a cloud server, an entertainment provider server, etc.). In some embodiments, the communication server 605 may provide updates to the communication system 620 when new versions of software or firmware become available. In other embodiments, various functions described below as being attributed to the communication system 620 can instead be performed entirely or in part on the communication server 605. For example, in some embodiments, various processing or storage tasks may be offloaded from the communication system 620 and instead performed on the communication server 120.

The communication system 620 includes one or more user input devices 622, a microphone sub-system 624, a camera sub-system 626, a network interface 628, a processor 630, a storage medium 650, a display sub-system 660, and an audio sub-system 670. In other embodiments, the communication system 620 may include additional, fewer, or different components.

The communication server 605, the communication system 620, and the client devices 615 cooperatively and/or individually maintain and enforce one or more privacy settings for users in various embodiments. A privacy setting of a user determines how particular information associated with a user can be shared in association with information identifying the user (e.g., personal identifying information (PII)). In some embodiments, the communication system 620 retrieves privacy settings for a user from a user profile of the user and/or the communication server 605 (e.g., may pull it from a node associated with a user in a social graph). In one embodiment, a privacy setting specifies particular information associated with a user and identifies other entities with whom the specified information may be shared. Examples of entities with which information can be shared may include other users, applications, third-party systems, or any entity that can potentially access the information. Examples of information that can be shared include a color preference profile of the user.

The user input device 622 comprises hardware that enables a user to interact with the communication system 620. The user input device 622 can comprise, for example, a touchscreen interface, a game controller, a keyboard, a mouse, a joystick, a voice command controller, a gesture recognition controller, a remote control receiver, or other input device. In an embodiment, the user input device 622 may include a remote control device that is physically separate from the user input device 622 and interacts with a remote controller receiver (e.g., an infrared (IR) or other wireless receiver) that may be integrated with or otherwise connected to the communication system 620. In some embodiments, the display sub-system 160 and the user input device 622 are integrated together, such as in a touchscreen interface. In other embodiments, user inputs may be received over the network 130 from a client device 615. For example, an application executing on a client device 615 may send commands over the network 130 to control the communication system 620 based on user interactions with the client device 615. In other embodiments, the user input device 622 may include a port (e.g., an HDMI port) connected to an external television that enables user inputs to be received from the television responsive to user interactions with an input device of the television. For example, the television may send user input commands to the communication system 620 via a Consumer Electronics Control (CEC) protocol based on user inputs received by the television.

The microphone sub-system 624 comprises one or more microphones (or connections to external microphones) that capture ambient audio signals by converting sound into electrical signals that can be stored or processed by other components of the communication system 620. The captured audio signals may be transmitted to the client devices 615 during an audio/video call or in an audio/video message. Additionally, the captured audio signals may be processed to identify voice commands for controlling functions of the communication system 620. In an embodiment, the microphone sub-system 624 comprises one or more integrated microphones. Alternatively, the microphone sub-system 624 may comprise an external microphone coupled to the communication system 620 via a communication link (e.g., the network 130 or other direct communication link). The microphone sub-system 624 may comprise a single microphone or an array of microphones. In the case of a microphone array, the microphone sub-system 624 may process audio signals from multiple microphones to generate one or more beamformed audio channels each associated with a particular direction (or range of directions).

The camera sub-system 626 comprises one or more cameras (or connections to one or more external cameras) that captures images and/or video signals. The captured images or video may be sent to the client device 615 during a video call or in a multimedia message, or may be stored or processed by other components of the communication system 620. Furthermore, in an embodiment, images or video from the camera sub-system 626 may be processed to for face detection, face recognition, gesture recognition, or other information that may be utilized to control functions of the communication system 620. In an embodiment, the camera sub-system 626 includes one or more wide-angle cameras for capturing a wide, panoramic, or spherical field of view of a surrounding environment. The camera sub-system 626 may include integrated processing to stitch together images from multiple cameras, or to perform image processing functions such as zooming, panning, de-warping, or other functions. In an embodiment, the camera sub-system 626 may include multiple cameras positioned to capture stereoscopic (e.g., three-dimensional images) or may include a depth camera to capture depth values for pixels in the captured images or video.

The network interface 628 facilitates connection of the communication system 620 to the network 130. For example, the network interface 628 may include software or hardware that facilitates communication of voice, video, and/or other data signals with one or more client devices 615 to enable voice and video calls or other operation of various applications executing on the communication system 620. The network interface 628 may operate according to any conventional wired or wireless communication protocols that enable it to communicate over the network 130. In an example implementation, the network interface 628 operates according to the UWB protocol to enable a secure communication link over the network 130 with a client device 615, as further described below in conjunction with FIGS. 2 and 3.

The display sub-system 660 comprises an electronic device or an interface to an electronic device for presenting images or video content. The display sub-system 660 renders visual content in accordance with instructions from the color customization module 180 and/or the user interface module 654. And once a color preference profile is available for a user, the display sub-system 660 may render content to the user (e.g., if they are logged into the communication system 620) in accordance with the color preference profile. For example, the display sub-system 660 may comprises an LED display panel, an LCD display panel, a projector, a virtual reality headset, an augmented reality headset, another type of display device, or an interface for connecting to any of the above-described display devices. The display sub-system 660 may include a touch-screen such that is can directly receive feedback from the user. The display sub-system 660 may be, e.g., the display 140. In an embodiment, the display sub-system 660 includes a display that is integrated with other components of the communication system 620. Alternatively, the display sub-system 620 comprises one or more ports (e.g., an HDMI port) that couples the communication system to an external display device (e.g., a television, a computer monitor).

The audio output sub-system 670 comprises one or more speakers or an interface for coupling to one or more external speakers that generate ambient audio based on received audio signals. In an embodiment, the audio output sub-system 670 includes one or more speakers integrated with other components of the communication system 620. Alternatively, the audio output sub-system 670 comprises an interface (e.g., an HDMI interface or optical interface) for coupling the communication system 620 with one or more external speakers (for example, a dedicated speaker system or television). The audio output sub-system 670 may output audio in multiple channels to generate beamformed audio signals that give the listener a sense of directionality associated with the audio. For example, the audio output sub-system may generate audio output as a stereo audio output or a multi-channel audio output such as 2.1, 3.1, 5.1, 7.1, or other standard configuration.

In embodiments in which the communication system 620 is coupled to an external media device such as a television or other monitor, the communication system 620 may lack an integrated display and/or an integrated speaker, and may instead only communicate audio/visual data for outputting via a display and speaker system of the external media device. For example, the communication system 620 may instruct the external media device to present one or more interfaces for customizing global color preference and memory color preference, and render visual content in accordance with the color preference profile.

The processor 630 operates in conjunction with the storage medium 650 (e.g., a non-transitory computer-readable storage medium) to carry out various functions attributed to the communication system 620 described herein. The storage medium 650 is a non-secure memory. For example, the storage medium 650 may store one or more modules or applications (e.g., user interface module 654, user applications 656, and the color customization module 180), embodied as instructions executable by the processor 630. The instructions, when executed by the processor 630, cause the processor 630 to carry out the functions attributed to the various modules or applications described herein. In an embodiment, the processor 630 may comprise a single processor or a multi-processor system.

In an embodiment, the storage medium 650 comprises a user interface module 654, the user applications 656, and the color customization module 180. In alternative embodiments, the storage medium 150 may comprise different or additional components.

The color customization module 180 may include the functionality of the user interface module 654 and/or control portions of the user interface module 654. The color customization module 180 controls the communications system 620 in order to facilitate the generation of a color preference profile that is customized to the user of the communication system 620.

The user interface module 654 comprises visual and/or audio elements and controls for enabling user interaction with the communication system 620. The controls may be physical buttons and/or portions of GUIs presented by the display sub-system 660. For example, the user interface module 654 may receive inputs from the user input device 622 to enable the user to select various functions of the communication system 620. For example, the user interface module 654 may generate GUIs for customization of memory color preference and global color preference in accordance with instructions from the color customization module 180. The GUIs may be similar or same as what is described above in reference to, e.g., FIGS. 1, 3, and 4.

In an example embodiment, the user interface module 154 includes a calling interface to enable the communication system 620 to make or receive voice or video calls over the network 130. To make a call, the user interface module 154 may provide controls to enable a user to select one or more contacts for calling, to initiate the call, to control various functions during the call, and to end the call. To receive a call, the user interface module 154 may provide controls to enable a user to accept an incoming call, to control various functions during the call, and to end the call. For video calls, the user interface module 154 may include a video call interface that displays remote video from a client device 615 together with various control elements such as volume control, an end call control, or various controls relating to how the received video is displayed or the received audio is outputted.

The user interface module 654 may furthermore enable a user to access user applications 656 or to control various settings of the communication system 620. In an embodiment, the user interface module 654 may enable customization of the user interface according to the color preference profile.

The user applications 656 comprise one or more applications that may be accessible by a user via the user interface module 654 to facilitate various functions of the communication system 620. For example, the user applications 656 may include a web browser for browsing web pages on the Internet, a picture viewer for viewing images, a media playback system for playing video or audio files, an intelligent virtual assistant for performing various tasks or services in response to user requests, or other applications for performing various functions. User applications 656 may store the information associated with the user of a client device 615 that is currently communicating with the communication system 620. The user applications 656 may be customized according to the information. For example, the user applications 656 includes a social networking application that enables integration of the communication system 620 with a user's social networking account. Here, for example, the user application 656 uses user account information (e.g., log-in credentials) to facilitate a personalized user experience by logging in the user to their social networking account to retrieve the color preference profile associated with the user.

### Additional Configuration Information

The foregoing description of the embodiments has been presented for illustration; it is not intended to be exhaustive or to limit the patent rights to the precise forms disclosed. Persons skilled in the relevant art can appreciate that many modifications and variations are possible considering the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
generating a first interface for customizing a global color preference;
receiving feedback from a user, via the first interface, describing a customized global color preference;
generating a second interface for customizing a memory color preference;
receiving feedback from the user, via the second interface, describing the customized memory color preference;
generating a color preference profile using the customized global color preference and the customized memory color preference, wherein the color preference profile describes the user's preference for how color is presented; and
associating the color preference profile with a user profile of the user, wherein visual content is rendered on a display in accordance with the color preference profile.

2. The method of claim 1, wherein generating the first interface comprises:
generating a plurality of controls corresponding to a plurality of display parameters, wherein the plurality of display parameters include contrast and saturation;
selecting an image that facilitates customization of the global color preference; and
instructing the display to present the plurality of controls and the selected image.

3. The method of claim 2, further comprising:
updating the first interface in response to receiving the feedback from the user describing the customized global color preference, wherein updating the first interface comprises:
modifying, in real time as the user provides user input into a control, of the one or more controls, that adjust a display parameter, the displayed image in accordance with the adjusted display parameter.

4. The method of claim 1, wherein the feedback of the user describing the customized global color preference comprises one or more of a global contrast value, a global saturation value, or a global brightness value.

5. The method of claim 1, wherein generating the second interface for customizing the memory color preference comprises:
selecting a canonical color;
selecting an image including the canonical color;
generating a plurality of controls corresponding to a plurality of display parameters, wherein the plurality of display parameters include hue and saturation; and
instructing the display to present the plurality of controls and the selected image.

6. The method of claim 5, further comprising updating the second interface in response to receiving feedback from the user describing the customized memory color preference, wherein updating the second interface comprises:
modifying, in real time as the user provides user input into a control, of the plurality of controls, that adjust a display parameter, the displayed image in accordance with the adjusted display parameter.

7. The method of claim 6, wherein the canonical color is selected from a set of canonical colors, the method further comprising:
selecting a second canonical color from the set of canonical colors;
selecting a second image including the second canonical color;
generating one or more controls corresponding to the plurality of display parameters; and
instructing the display to present the one or more controls and the second image,
wherein receiving feedback from the user, via the second interface, describing the customized memory color preference includes feedback pertaining to a display parameter value for the image and a display parameter value for the second image.

8. The method of claim 1, wherein the feedback of the user describing the customized memory color preference comprises one or more of a hue of a canonical color, a saturation value of the canonical color, or a brightness value of the canonical color.

9. The method of claim 1, wherein the global color preference describes a display parameter that is applied to a plurality of colors, the global preference including one or more of a contrast, color salutation, or brightness.

10. The method of claim 1, further comprising:
receiving image data depicting a plurality of objects rendered using default display parameters;
accessing the color preference profile using the user profile;
modifying the default display parameters based on the color preference profile; and
instructing a display to render the visual content in accordance with the modified display parameters.

11. The method of claim 1, further comprising:
uploading the color preference profile to a communication server, wherein the communication server, responsive to a request from a second device of the user, provides the user profile to the second device, such that visual content rendered on the second device are rendered in accordance with the color preference profile of the user.

12. The method of claim 1, wherein the memory color preference is represented by a three dimensional (3D) look up table (LUT).

13. A non-transitory computer-readable storage medium comprising stored instructions, the instructions when executed by a processor of a device, cause the device to:
generate a first interface for customizing a global color preference;
receive feedback from a user, via the first interface, describing a customized global color preference;
generate a second interface for customizing a memory color preference;
receive feedback from the user, via the second interface, describing the customized memory color preference;
generate a color preference profile using the customized global color preference and the customized memory color preference, wherein the color preference profile describes the user's preference for how color is presented; and
associate the color preference profile with a user profile of the user, wherein visual content is rendered on a display of the device in accordance with the color preference profile.

14. The non-transitory computer-readable storage medium of claim 13, wherein the stored instructions to generate the first interface further comprises stored instructions that when executed causes the device to:
generate a plurality of controls corresponding to a plurality of display parameters, wherein the plurality of display parameters include contrast and saturation;
select an image that facilitates customization of the global color preference; and
instruct a display of the device to present the plurality of controls and the selected image.

15. The non-transitory computer-readable storage medium of claim 14, further comprising stored instructions that when executed cause the device to update the first interface in response to receiving the feedback from the user describing the customized global preference.

16. The non-transitory computer-readable storage medium of claim 15, wherein the stored instructions to update the first interface further comprises stored instructions that when executed causes the device to:
modify, in real time as the user provides user input into a control, of the one or more controls, that adjust a display parameter, the displayed image in accordance with the adjusted display parameter.

17. A device comprising:
a display configured to display visual content in accordance with a color preference profile; and
a controller configured to:
generate a first interface for customizing a global color preference, wherein the first interface is presented via the display;
receive feedback from a user, via the first interface, describing a customized global color preference,
generate a second interface for customizing a memory color preference, wherein the second interface is presented via the display;
receive feedback from the user, via the second interface, describing the customized memory color preference,
generate the color preference profile using the customized global color preference and the customized memory color preference, wherein the color preference profile describes the user's preference for how color is presented.

18. The device of claim 17, wherein the controller is further configured to:
generate a plurality of controls corresponding to a plurality of display parameters, wherein the plurality of display parameters include contrast and saturation;
select an image that facilitates customization of the global color preference; and
instruct the display to present the plurality of controls and the selected image.

19. The device of claim 18, wherein the controller is further configured to:
select a canonical color;
select an image including the canonical color;
generate a plurality of controls corresponding to a plurality of display parameters, wherein the plurality of display parameters include hue and saturation; and
instruct the display to present the one or more controls and the selected image.

20. The device of claim 19, wherein the controller is further configured to:
modify, in real time as the user provides user input into a control, of the one or more controls, that adjust a display parameter, the displayed image in accordance with the adjusted display parameter.
